(19) United States
(12) Patent Application Publication
(10) Pub. No.: US 2026/0172328 A1
(43) Pub. Date: Jun. 18, 2026

(54) APPARATUSES AND COMMUNICATION METHODS FOR AI/ML OPERATION

(71) Applicant: GUANGDONG OPPO MOBILE TELECOMMUNICATIONS CORP., LTD., Dongguan (CN)

(72) Inventors: Alla GOLDNER, Tel Aviv (IL); Jingran CHEN, Dongguan (CN); Yang XU, Dongguan (CN)

(21) Appl. No.: 19/536,790

(22) Filed: Feb. 11, 2026

Related U.S. Application Data
(63) Continuation of application No. PCT/CN2023/113709, filed on Aug. 18, 2023.

(51) Int. Cl. H04L 41/5009; H04L 41/14; H04L 41/40; H04W 48/16

(52) U.S. Cl. CPC H04L 41/5009; H04L 41/14; H04L 41/40; H04W 48/16

(57) ABSTRACT

A communication method for artificial intelligence (AI)/machine learning (ML) operation includes discovering a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model.

### CROSS REFERENCE TO RELATED APPLICATION(S)

This application is a continuation of International Application No. PCT/CN2023/113709, filed Aug. 18, 2023, the entire disclosure of which is incorporated herein by reference.

### TECHNICAL FIELD

The present disclosure relates to the field of communication systems, and more particularly, to a network device and a communication method for artificial intelligence (AI)/machine learning (ML) operation such as AI/ML trustworthiness service regarding a registration in a network repository function (NRF) and discovery.

### BACKGROUND

There is currently standardization activity in 3rd generation partnership project (3GPP) work studying artificial intelligence/machine learning (AI/ML) functionality. However, in current technologies, aspects for AI/ML trustworthiness service have not been identified in a 5G core network (5GC).

Therefore, there is a need for apparatuses and communication methods for artificial intelligence (AI)/machine learning (ML) operation such as AI/ML trustworthiness service, which can address these and other issues.

### SUMMARY

In a first aspect of the present disclosure, a communication method for artificial intelligence (AI)/machine learning (ML) operation, wherein the method is implemented in a network entity, includes discovering a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model.

In a second aspect of the present disclosure, a network device includes a memory, a transceiver, and a processor coupled to the memory and the transceiver. The network device is configured to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of non-roaming 5G system architecture configured to implement some embodiments presented herein.

FIG. 2 is a block diagram of a data collection architecture from any 5GC network function (NF) configured to implement some embodiments presented herein.

FIG. 3 is a block diagram of a data collection architecture using data collection coordination configured to implement some embodiments presented herein.

FIG. 4 is a block diagram of a network data analytics exposure architecture configured to implement some embodiments presented herein.

FIG. 5 is a block diagram of a network data analytics exposure architecture using data collection coordination configured to implement some embodiments presented herein.

FIG. 6 is a block diagram of a trained ML model provisioning architecture configured to implement some embodiments presented herein.

FIG. 7 is a block diagram of a network device according to an embodiment of the present disclosure.

FIG. 8 is a flowchart illustrating a communication method for artificial intelligence (AI)/machine learning (ML) operation according to an embodiment of the present disclosure.

FIG. 9 is a block diagram of a communication device according to an embodiment of the present disclosure.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

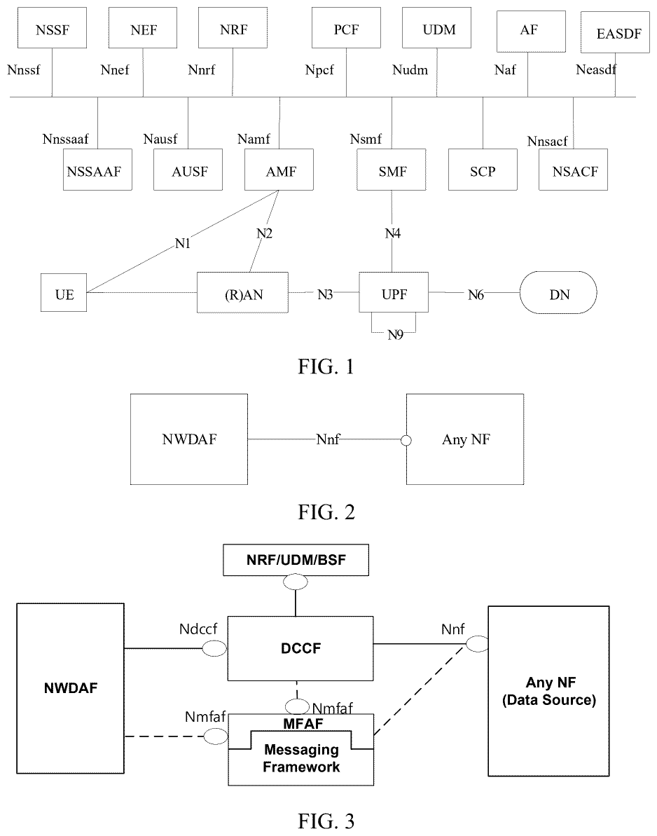

FIG. 1 illustrates a non-roaming 5G system architecture configured to implement some embodiments presented herein. In the 5G non-roaming system architecture, network functions communicate with each other over a service-based interface in a core network (CN). A user equipment (UE) may communicate with the core network to establish control signaling and enable the UE to use services from the CN. Examples of control signaling functions are registration, connection and mobility management, authentication and authorization, session management, etc. After control signaling have been established, the UE can then utilize the user plane functionality to send and receive data to and from a data network (DN), e.g., the internet.

The 5G system architecture includes the following network functions (NF): Authentication Server Function (AUSF), Access and Mobility Management Function (AMF), Data Network (DN), e.g., operator services, Internet access or 3rd party services, Unstructured Data Storage Function (UDSF), Network Exposure Function (NEF), Network Repository Function (NRF), Network Slice Admission Control Function (NSACF), Network Slice-specific and SNPN Authentication and Authorization Function (NSSAAF), Network Slice Selection Function (NSSF), Policy Control Function (PCF), Session Management Function (SMF), Unified Data Management (UDM), Unified Data Repository (UDR), User Plane Function (UPF), UE radio Capability Management Function (UCMF), Application Function (AF), User Equipment (UE), (Radio) Access Network ((R)AN), 5G-Equipment Identity Register (5G-EIR), Network Data Analytics Function (NWDAF), CHarging Function (CHF), Time Sensitive Networking AF (TSN AF), Time Sensitive Communication and Time Synchronization Function (TSCTSF), Data Collection Coordination Function (DCCF), Analytics Data Repository Function (ADRF), Messaging Framework Adaptor Function (MFAF), and Non-Seamless WLAN Offload Function (NSWOF).

The following descriptions highlight some of the capabilities of the network functions (NFs) from FIG. 1 that are involved with control signaling.

Access and Mobility Function (AMF): The UE sends an NI message through the RAN node to the AMF to perform control plane signaling such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Authentication Server Function (AUSF): The AUSF supports authentication of UEs for 3GPP and untrusted non-3GPP accesses.

Unified Data Management/Repository (UDM/UDR): The UDM/UDR supports generation of 3GPP AKA Authentication Credentials, user identification handling, subscription management and storage, etc.

Network Slice Selection Function (NSSF): The NSSF is involved with aspects of network slice management such as selection of network slice instances for UEs, management of NSSAIs, etc.

Network Repository Function (NRF): The NRF supports service discovery function in the 5G network.

Network Exposure Function (NEF): The NEF supports the exposure of capabilities and events in the core network to third parties, Application Functions (AF), Edge Computing, etc.

The RAN node offers communication access from the UE to the core network for both control plane and user plane communications. A UE establishes a PDU session with the CN to send data traffic over the user plane through the (R)AN and UPF nodes of the 5G system (5GS). Uplink traffic is sent by the UE and downlink traffic is received by the UE using the established PDU session. Data traffic flows between the UE and the DN through the intermediary nodes: (R)AN and UPF.

In some embodiments, a storage for a trustworthy service may be defined in a non-roaming 5G system architecture as illustrated in FIG. 1, and ways to access this storage for appropriate network function (NF) supporting trustworthiness may be selected for the operation, if there are trustworthiness requirements in the non-roaming 5G system architecture as illustrated in FIG. 1.

As there is an increasing usage in AI/ML in mobile networks, there is an increasing need to make the AI/ML supported services trustworthy. The following terms in a proposal for rules on AI may include:

Trustworthy Machine Learning: This may put forward a set of seven key requirements that the Machine Learning systems may meet for the set of seven key requirements to be considered trustworthy. The details on each of those requirements are as follows:

Human agency and oversight: AI systems may empower human beings, allowing them to make informed decisions and fostering their fundamental rights. At the same time, proper oversight mechanisms need to be ensured, which can be achieved through human-in-the-loop, human-on-the-loop, and human-in-command approaches.

Technical robustness and safety: AI systems need to be resilient and secure. They need to be safe, ensuring a fallback plan in case something goes wrong, as well as being accurate, reliable, and reproducible. That may be the only way to ensure that also unintentional harm can be minimized and prevented.

Privacy and data governance: Besides ensuring full respect for privacy and data protection, adequate data governance mechanisms also be ensured, considering the quality and integrity of the data, and ensuring legitimized access to data.

Transparency: The data, system and AI business models are transparent. Traceability mechanisms can help achieving this. Moreover, AI systems and their decisions can be explained in a manner adapted to the stakeholder concerned. Humans need to be aware that they are interacting with an AI system and can be informed of the system's capabilities and limitations.

Diversity, non-discrimination, and fairness: Unfair bias is avoided, as it could have multiple negative implications, from the marginalization of vulnerable groups to the exacerbation of prejudice and discrimination. Fostering diversity, AI systems should be accessible to all, regardless of any disability, and involve relevant stakeholders throughout their entire life circle.

Accountability: Mechanisms can be put in place to ensure responsibility and accountability for AI systems and their outcomes. Auditability, which enables the assessment of algorithms, data and design processes plays a key role therein, especially in critical applications. Moreover, adequate an accessible redress can be ensured.

Societal and environmental well-being: AI systems can benefit all human beings, including future generations. It can hence be ensured that they are sustainable and environmentally friendly. Moreover, they can consider the environment, including other living beings, and their social and societal impact can be carefully considered.

As there is an ongoing 3GPP standardization effort of defining AI/ML functionality in the mobile networks, there is a need to extend this standardization and define trustworthy aspects related to the AI/ML functionality in the mobile networks including the corresponding parameters, storage of the parameters, network functions and network services, dealing with the parameters. Some embodiments of the present disclosure are about defining a storage for a trustworthy service in the network, and the ways to access the storage for appropriate network function supporting trustworthiness are selected for the operation, if there are trustworthiness requirements in the network. Some embodiments of the present disclosure analyze 5G architecture and requirements and suggest how to embed trustworthiness aspects into the 5G architecture and requirements.

FIG. 2 illustrates a data collection architecture from any 5GC network function (NF) configured to implement some embodiments presented herein. As depicted in FIG. 2, the 5G system architecture allows NWDAF to collect data from any 5GC NF. The NWDAF belongs to the same public land mobile network (PLMN) as the 5GC NF that provides the data. The Nnf interface is defined for the NWDAF to request subscription to data delivery for a particular context, to cancel subscription to data delivery and to request a specific report of data for a particular context. The 5G system architecture allows NWDAF to retrieve the management data from network management function (OAM) by invoking OAM services. The 5G system architecture allows NWDAF to collect data from any 5GC NF or OAM using a data collection and coordination function (DCCF) with associated Ndccf services. The 5G system architecture allows NWDAF and DCCF to collect data from an NWDAF with associated Nnwdaf_DataManagement services. The 5G system architecture allows MFAF to fetch data from an NWDAF with associated Nnwdaf_DataManagement service.

FIG. 3 illustrates a data collection architecture using data collection coordination configured to implement some embodiments presented herein. As depicted in FIG. 3, the Ndccf interface is defined for the NWDAF to support subscription request(s) for data delivery from a DCCF, to cancel subscription to data delivery and to request a specific report of data. If the data is not already being collected, the DCCF requests the data from the data source using Nnf services. The DCCF may collect the data and deliver it to the NWDAF or the DCCF may rely on a messaging framework to collect data from the NF and deliver it to the NWDAF.

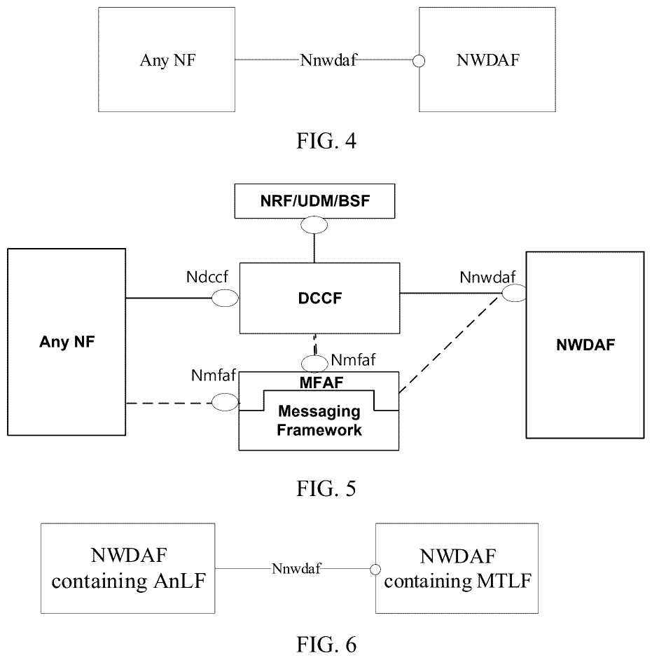

FIG. 4 illustrates a network data analytics exposure architecture configured to implement some embodiments presented herein. As depicted in FIG. 4, the 5G system architecture allows any 5GC NF to request network analytics information from NWDAF supporting analytics logical function (AnLF). The NWDAF supporting AnLF may refer to the NWDAF containing AnLF. The NWDAF belongs to the same PLMN as the 5GC NF that consumes the analytics information. The Nnwdaf interface is defined for 5GC NFs, to request subscription to network analytics delivery for a particular context, to cancel subscription to network analytics delivery and to request a specific report of network analytics for a particular context. The 5G System architecture also allows other consumers such as OAM and charging enablement function (CEF) to request network analytics information from NWDAF. The 5G system architecture allows any NF to obtain analytics from an NWDAF using a DCCF function with associated Ndccf services. The 5G system architecture allows NWDAF and DCCF to request historical analytics from an NWDAF with associated Nnwdaf_DataManagement services. The 5G system architecture allows MFAF to fetch historical analytics from an NWDAF with associated Nnwdaf_DataManagement service.

FIG. 5 illustrates a network data analytics exposure architecture using data collection coordination configured to implement some embodiments presented herein. As depicted in FIG. 5, the Ndccf interface is defined for any NF to support subscription request(s) to network analytics, to cancel subscription for network analytics and to request a specific report of network analytics. If the analytics is not already being collected, the DCCF requests the analytics from the NWDAF using Nnwdaf services. The DCCF may collect the analytics and deliver it to the NF, or the DCCF may rely on a messaging framework to collect analytics and deliver it to the NF.

FIG. 6 illustrates a trained ML model provisioning architecture configured to implement some embodiments presented herein. As depicted in FIG. 6, the 5G system architecture allows NWDAF supporting analytics logical function (AnLF) to use trained ML model provisioning services from another NWDAF supporting model training logical function (MTLF). The Nnwdaf interface is used by an NWDAF supporting AnLF to request and subscribe to trained ML model provisioning services. The NWDAF supporting AnLF may be the only consumer of trained ML model provisioning services. The NWDAF supporting AnLF may refer to the NWDAF containing AnLF. The NWDAF supporting MTLF may refer to the NWDAF containing MTLF.

An NWDAF may contain the following logical functions:

Analytics logical function (AnLF): A logical function in NWDAF, which performs inference, derives analytics information (i.e., derives statistics and/or predictions based on analytics consumer request) and exposes analytics service i.e., Nnwdaf_AnalyticsSubscription or Nnwdaf_AnalyticsInfo.

Model training logical function (MTLF): A logical function in NWDAF, which trains machine learning (ML) models and exposes new training services (e.g., providing trained ML model).

NWDAF can contain an MTLF or an AnLF or both logical functions. Analytics information are either statistical information of the past events, or predictive information. Different NWDAF instances may be present in the 5GC, with possible specializations per type of analytics. The capabilities of a NWDAF instance are described in the NWDAF profile stored in the NRF. To guarantee the accuracy of analytics output for an analytics ID, based on the UE abnormal behavior analytics from itself or other NWDAF including abnormal UE list and the observed time window, the NWDAF is to detect and may delete the input data from the abnormal UE(s) and then may generate a new ML model and/or analytics outputs for the analytics ID without the input data related to abnormal UE list during the observed time window and then send/update the ML model information and/or analytics outputs to the subscribed NWDAF service consumer.

In order to support NFs to discover and select an NWDAF instance supporting MTLF, AnLF, or both, that is able to provide the required service (e.g. analytics exposure or ML model provisioning) for the required type of analytics, each NWDAF instance should provide the list of supported analytics ID(s) (possibly per supported service) when registering to the NRF, in addition to other NRF registration elements of the NF profile. NFs requiring the discovery of an NWDAF instance that provides support for some specific service(s) for a specific type of analytics may query the NRF for NWDAFs supporting the required service(s) and the required analytics ID(s). The consumers, i.e., 5GC NFs and OAM, decide how to use the data analytics provided by NWDAF. The interactions between 5GC NF(s) and the NWDAF take place within a PLMN. The NWDAF has no knowledge about NF application logic. The NWDAF may use subscription data but only for statistical purpose. The NWDAF architecture allows for arranging multiple NWDAF instances in a hierarchy/tree with a flexible number of layers/branches. The number and organization of the hierarchy layers, as well as the capabilities of each NWDAF instance remain deployment choices.

In a hierarchical deployment, NWDAFs may provide data collection exposure capability for generating analytics based on the data collected by other NWDAFs, when DCCF, MFAF are not present in the network. In order to make NWDAF discoverable in some network deployments, NWDAF may be configured (e.g., for UE mobility analytics) to register in UDM (Nudm_UECM_Registration service operation) for the UE(s) it is serving and for the related analytics ID(s). Registration in UDM may take place at the time the NWDAF starts serving the UE(s) or collecting data for the UE(s). Deregistration in UDM takes place when NWDAF deletes the analytics context for the UE(s) for a related analytics ID.

Some solutions of the present disclosure propose to include a trustworthy service in the network. In some embodiments, a communication method for artificial intelligence (AI)/machine learning (ML) operation includes discovering a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model. In details, in some examples, NWDAF supports AnLF capabilities, and/or NWDAF supports MTLF capabilities. Some embodiments of this innovation define how to discover trustworthiness capabilities of the corresponding analytics and the corresponding models, in the following solutions:

1. NWDAF supporting AnLF with analytics parameters including trustworthiness.

2. NWDAF supporting MTLF with analytics parameters corresponding to the trained ML models. Optionally, existing model provisioning service is re-used and extended to include trustworthiness parameters. Optionally, new service for trustworthiness is introduced.

3. Additionally, for the case there are no NWDAFs deployed in the network, or there are no NWDAFs supporting MTLF, or there are NWDAFs supporting MTLFs but not for the relevant Model IDs, and models might be directly used by different Network Functions, models might be directly provisioned into NRF and discovered by the corresponding Network Function(s).

### NWDAF Discovery and Selection

The NWDAF service consumer selects an NWDAF that supports requested analytics information and required analytics capabilities and/or requested ML Model Information by using the NWDAF discovery principles. In some embodiments, NWDAF may be enabled to support MTLF with Trustworthiness capability for ML models. In some embodiments, NWDAF may be enabled to support AnLF with Trustworthiness capability for analytics. Different deployments may require different discovery and selection parameters. Different ways to perform discovery and selection mechanisms depend on different types of analytics/data (NF related analytics/data and UE related analytics/data). NF related refers to analytics/data that do not require a SUPI nor group of SUPIs (e.g., NF load analytics). UE related refers to analytics/data that requires SUPI or group of SUPIs (e.g., UE mobility analytics).

In order to discover an NWDAF supporting AnLF using the NRF:

If the analytics is related to NF(s) and the NWDAF service consumer (other than an NWDAF) cannot provide an Area of Interest for the requested data analytics, the NWDAF service consumer may select an NWDAF with large serving area from the candidate NWDAFs from discovery response. Alternatively, in case the consumer receives NWDAF(s) with aggregation capability, the consumer preferably selects an NWDAF with aggregation capability with large serving area.

If the selected NWDAF cannot provide the requested data analytics, e.g., due to the NF(s) to be contacted being out of serving area of the NWDAF, the selected NWDAF might reject the analytics request/subscription, or it might query the NRF with the service area of the NF to be contacted to determine another target NWDAF. If the analytics is related to UE(s) and the NWDAF service consumer (other than an NWDAF) cannot provide an Area of Interest for the requested data analytics, the NWDAF service consumer may select an NWDAF with large serving area from the candidate NWDAFs from discovery response. Alternatively, in case the consumer receives NWDAF(s) with aggregation capability, the consumer preferably selects an NWDAF with aggregation capability with large serving area.

If a selected NWDAF cannot provide analytics for the requested UE(s) (e.g. the NWDAF serves a different serving area), the selected NWDAF might reject the analytics request/subscription or it might determine the AMF serving the UE, request UE location information from the AMF and query the NRF with the tracking area where the UE is located to discover another target NWDAF serving the area where the UE(s) is located. If the analytics are related to UE(s) and if NWDAF instances indicate weights for TAIs in their profile, the NWDAF service consumer may use the weights for TAIs to decide which NWDAF to select. If the NWDAF service consumer needs to discover an NWDAF supporting an AnLF with Accuracy checking capability, the consumer may query NRF providing also the accuracy checking capability in the discovery request. If the NWDAF service consumer needs to discover an NWDAF that is able to collect data from particular data sources identified by their NF Set IDs or NF types, the consumer may query NRF providing the NF Set IDs or NF types in the discovery request.

In order to discover an NWDAF that has registered in UDM for a given UE:

NWDAF service consumers or other NWDAFs interested in UE related data or analytics, if supported, may make a query to UDM to discover an NWDAF instance that is already serving the given UE. If an NWDAF service consumer needs to discover NWDAFs with data collection exposure capability, the NWDAF service consumer may discover via NRF the NWDAF(s) that provide the Nnwdaf_DataManagement service and their associated NF type of data sources or their associated NF Set ID of data sources.

In order to discover an NWDAF supporting MTLF via NRF:

An NWDAF supporting MTLF shall include the ML model provisioning services (i.e. Nnwdaf_MLModelProvision, Nnwdaf_MLModelInfo) as one of the supported services during the registration in NRF when trained ML models are available for one or more Analytics ID(s). The NWDAF supporting MTLF may provide to the NRF a (list of) Analytics ID(s) corresponding to the trained ML models and possibly the ML Model Filter Information for the trained ML model per Analytics ID(s), if available. In this Release of the specification, only the S-NSSAI(s) and Area(s) of Interest from the ML Model Filter Information for the trained ML model per Analytics ID(s) may be registered into the NRF during the NWDAF supporting MTLF registration. For each Analytics ID, if the NWDAF supporting MTLF supports ML Model interoperability, the NWDAF supporting MTLF may also include, in the registration to the NRF, an ML Model Interoperability indicator.

The ML Model Interoperability indicator comprises a list of NWDAF providers (vendors) that are allowed to retrieve ML models from this NWDAF supporting MTLF. It also indicates that the NWDAF supporting MTLF supports the interoperable ML models requested by the NWDAFs from the vendors in the list.

The S-NSSAI(s) and Area(s) of Interest from the ML Model Filter Information are within the indicated S-NSSAI and NWDAF Serving Area information in the NF profile of the NWDAF supporting MTLF, respectively.

During the discovery of NWDAF supporting MTLF, a consumer (i.e. an NWDAF supporting AnLF) may include in the request the target NF type (i.e. NWDAF), the Analytics ID(s), the S-NSSAI(s), Area(s) of Interest of the Trained ML Model required, ML Model Interoperability indicator and NF consumer information. The NRF returns one or more candidate for instances of NWDAF supporting MTLF to the NF consumer and each candidate for instance of NWDAF supporting MTLF includes the Analytics ID(s) and possibly the ML Model Filter Information for the available trained ML models, if available.

If the NWDAF service consumer needs to discover an NWDAF supporting an MTLF with accuracy checking capability, the consumer may query NRF also providing the accuracy checking capability in the discovery request.

In order to discover an NWDAF supporting MTLF with Federated Learning (FL) capability via NRF:

An NWDAF supporting MTLF supporting FL as a server shall additionally include FL capability type (i.e., FL server), Time interval supporting FL as FL capability information during the registration in NRF. An NWDAF supporting MTLF supporting FL as a client shall additionally include FL capability type (i.e., FL client), Time interval supporting FL as FL capability information during the registration in NRF, and it may also include NF type(s) where data can be collected as input for local model training. An NWDAF supporting MTLF may indicate to support both FL server and FL client in the FL capability for specific Analytics ID.

During the discovery of NWDAF supporting MTLF as FL server, a consumer (e.g., a NWDAF supporting MTLF) includes in the request the FL capability type as FL server, Time Period of Interest and ML model Filter information for the trained ML model(s) per Analytics ID(s), if available. The NRF returns one or more candidate for instances of NWDAF supporting MTLF as FL server to the consumer. During the discovery of NWDAF supporting MTLF as FL client, a consumer (e.g., an FL server) includes in the request FL capability type as FL client, Time Period of Interest, ML model Filter information for the trained ML model(s) per Analytics ID(s), a list of NF type(s). The NRF returns one or more candidate for instances of NWDAF supporting MTLF as FL client to the consumer. The service consumer to discover an NWDAF supporting MTLF with FL capability is limited to NWDAF supporting MTLF.

A PCF may learn which NWDAFs being used by AMF, SMF and UPF for a specific UE, via signaling. This enables a PCF to select the same NWDAF instance that is already being used for a specific UE. In the roaming architecture, the NWDAF with roaming exchange capability (RE-NWDAF) to request analytics or input data is discovered via the NRF. A consumer in the same PLMN as the RE-NWDAF discovers the RE-NWDAF by querying for an NWDAF where the roaming exchange capability is indicated in its NRF profile. A consumer in a peer PLMN (i.e., RE-NWDAF) discovers the RE-NWDAF by querying for an NWDAF in the target PLMN that is supporting the specific services defined for roaming. A RE-NWDAF discovers the RE-NWDAF in a different PLMN (i.e., HPLMN or VPLMN) using a procedure (if delegated discovery is not used), where the detailed parameters are determined based on the analytics request or subscription from the consumer 5GC NF, operator policy, user consent and/or local configuration.

### Solution 1:

NWDAF may be enabled to support MTLF with Trustworthiness capability for ML models.

An NWDAF supporting MTLF with Trustworthiness capability may be locally configured with (a set of) IDs of NWDAFs supporting MTLF with Trustworthiness capability and the Analytics ID(s) supported by each NWDAF supporting MTLF with Trustworthiness capability to retrieve trained ML models and the corresponding trustworthiness parameters or may use the NWDAF discovery procedure as further specified for discovering NWDAFs supporting MTLF with Trustworthiness capability.

In order to discover an NWDAF supporting MTLF with Trustworthiness capability via NRF: An NWDAF supporting MTLF with Trustworthiness capability may include at least one of the followings.

The ML model provisioning services (i.e., Nnwdaf_MLModelProvision, Nnwdaf_MLModelInfo) as one of the supported services: NWDAF supporting MTLF with trustworthiness capability may provide the ML model provisioning services during the registration in NRF when trained ML models are available for one or more Analytics ID(s).

In some examples, wherein the one or more ML model provisioning services and/or the one or more ML trustworthiness services include priorities for fall-back mechanism between a trustworthy AI solution, a non-trustworthy AI solution, and a non-AI solution to ensure safety; and/or (a list of) one or more analytics IDs corresponding to the trained ML models and a ML model filter information for the trained ML model per analytics ID.

In some examples, the ML model filter information includes at least one of following trustworthiness related parameters: a data type; a version; a sampling frequency; sampling weights; a model weight in case of chaining/merging with another model; labelled/un-labelled data; an explainability level; a risk level (e.g., unacceptable, high, limited); a fairness; a robustness; a privacy; a security; a safety; a reliability; a traceability; a ML decision confidence score (numerical value that represents the dependability/quality of a given decision generated by an AI/ML-inference function); and/or a value quality score of data, which is the numerical value that represents the dependability/quality of a given observation and measurement type. These parameters may be added to ML Model Filter information on top of already existing parameters.

ML trustworthiness service as one of the supported services: NWDAF supporting MTLF with Trustworthiness capability may provide the ML trustworthiness service during the registration in NRF when trained ML models are available for one or more Analytics ID(s). ML Trustworthiness service may contain information about various trustworthiness parameters resulted from the corresponding model training by the MTLF, such as: priorities for Fall-back mechanism between Trustworthy AI, non-trustworthy AI and non-AI solutions to ensure safety and/or a (list of) Analytics ID(s) corresponding to the trained ML models and ML Model Filter Information for the trained ML model per Analytics ID(s).

In some examples, the ML model filter information includes at least one of following trustworthiness related parameters: a data type; a version; a sampling frequency; sampling weights; a model weight in case of chaining/merging with another model; labelled/un-labelled data; an explainability level; a risk level (e.g., unacceptable, high, limited); a fairness; a robustness; a privacy; a security; a safety; a reliability; a traceability; a ML decision confidence score (numerical value that represents the dependability/quality of a given decision generated by an AI/ML-inference function); and/or a value quality score of data, which is the numerical value that represents the dependability/quality of a given observation and measurement type. These parameters may be added to ML Model Filter information on top of already existing parameters. In some examples, List of the Analytics IDs is correlated between ML model provisioning services and ML trustworthiness service.

### Solution 2:

NWDAF may be enabled to support AnLF with Trustworthiness capability for analytics.

An NWDAF supporting AnLF with Trustworthiness capability may be locally configured with (a set of) IDs of NWDAFs supporting AnLF with Trustworthiness capability and the Analytics ID(s) supported by each NWDAF supporting AnLF with Trustworthiness capability or may use the NWDAF discovery procedure as further specified for discovering NWDAFs supporting AnLF with Trustworthiness capability. In order to discover an NWDAF supporting AnLF with Trustworthiness capability via NRF: Per each Analytics ID, the following information may be included for the corresponding trustworthiness related parameters per Analytics Filter Information: risk level (e.g., unacceptable, high, limited); fairness; robustness; privacy; security; safety; reliability; and/or traceability.

### Solution 3:

Alternative solution (for the case there is no NWDAF deployed in the network, or there are no NWDAF supporting MTLF, or there are NWDAF supporting MTLFs but not for the relevant Model IDs) and (Models might be directly used by a different Network Functions): NRF may include Trustworthiness capabilities provisioning per each ML Model, hence ML Model Filter information per each model may include the following trustworthiness related parameters: a data type; a version; a sampling frequency; sampling weights; a model weight in case of chaining/merging with another model; labelled/un-labelled data; an explainability level; a risk level (e.g., unacceptable, high, limited); a fairness; a robustness; a privacy; a security; a safety; a reliability; a traceability; a ML decision confidence score (numerical value that represents the dependability/quality of a given decision generated by an AI/ML-inference function); and/or a value quality score of data, which is the numerical value that represents the dependability/quality of a given observation and measurement type. These parameters may be added to ML Model Filter information on top of already existing parameters.

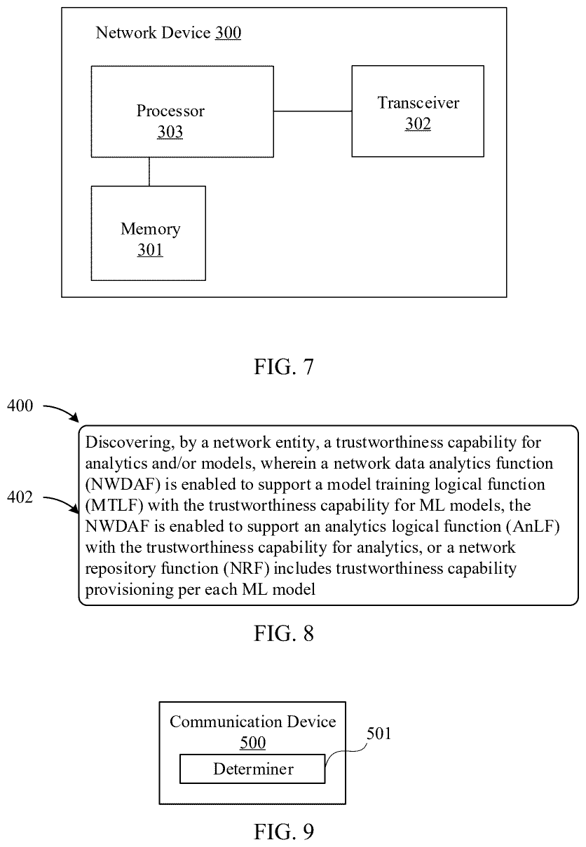

FIG. 7 illustrates an example of a network device 300 according to an embodiment of the present disclosure. The network device 300 is configured to implement some embodiments of the disclosure. Some embodiments of the disclosure may be implemented into the network device 300 using any suitably configured hardware and/or software. The network device 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the memory 301 stores executable instructions that when executed by the processor cause the processor 303 to effectuate operations including: discovering a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model.

FIG. 8 illustrates a communication method for artificial intelligence (AI)/machine learning (ML) operation according to an embodiment of the present disclosure. FIG. 8 is an example of a communication method 400 for artificial intelligence (AI)/machine learning (ML) operation according to an embodiment of the present disclosure. The communication method 400 for artificial intelligence (AI)/machine learning (ML) operation is configured to implement some embodiments of the disclosure. Some embodiments of the disclosure may be implemented into the communication method 400 for artificial intelligence (AI)/machine learning (ML) operation using any suitably configured hardware and/or software. In some embodiments, the communication method 400 for artificial intelligence (AI)/machine learning (ML) operation includes: an operation 402, discovering, by a network entity, a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model.

FIG. 9 illustrates a communication device according to an embodiment of the present disclosure. FIG. 9 illustrates that, in some embodiments, a communication device 500 includes a determiner 501 configured to discover a trustworthiness capability for analytics and/or models, wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) includes trustworthiness capability provisioning per each ML model.

In some embodiments, discovering the trustworthiness capability for analytics and/or model includes a network data analytics function (NWDAF) being enabled to support a model training logical function (MTLF) with the trustworthiness capability for ML models. In some embodiments, the NWDAF supporting the MTLF with the trustworthiness capability is locally configured with one or more NWDAF identifiers (IDs) and/or one or more analytics IDs. In some embodiments, the one or more NWDAF IDs and/or the one or more analytics IDs supported by each NWDAF supporting the MTLF with the trustworthiness capability are configured to retrieve trained ML models and corresponding trustworthiness parameters. In some embodiments, the network entity is configured to use a NWDAF discovery procedure to discover one or more NWDAFs supporting the MTLF with the trustworthiness capability. In some embodiments, the network entity is configured to discover the NWDAF supporting the MTLF with the trustworthiness capability via a network repository function (NRF).

In some embodiments, the NWDAF supporting the MTLF with the trustworthiness capability includes one or more ML model provisioning services and/or one or more ML trustworthiness services. In some embodiments, the NWDAF supporting the MTLF with the trustworthiness capability provides the one or more ML model provisioning services and/or the one or more ML trustworthiness services during a registration in the NRF when trained ML models are available for one or more analytics IDs. In some embodiments, the one or more ML model provisioning services and/or the one or more ML trustworthiness services include priorities for fall-back mechanism between a trustworthy AI solution, a non-trustworthy AI solution, and a non-AI solution to ensure safety; and/or one or more analytics IDs corresponding to the trained ML models and a ML model filter information for the trained ML model per analytics ID. In some embodiments, the ML model filter information includes at least one of following trustworthiness related parameters: a data type; a version; a sampling frequency; sampling weights; a model weight in case of chaining/merging with another model; labelled/un-labelled data; an explainability level; a risk level; a fairness; a robustness; a privacy; a security; a safety; a reliability; a traceability; a ML decision confidence score; and/or a value quality score of data. In some embodiments, a list of the analytics IDs is correlated between the one or more ML model provisioning services and the one or more ML trustworthiness service.

In some embodiments, discovering the trustworthiness capability for analytics and/or model includes the NWDAF being enabled to support an analytics logical function (AnLF) with the trustworthiness capability for analytics. In some embodiments, the NWDAF supporting the AnLF with the trustworthiness capability is locally configured with one or more NWDAF IDs and/or one or more analytics IDs. In some embodiments, the one or more NWDAF IDs and/or the one or more analytics IDs supported by each NWDAF supporting the AnLF with the trustworthiness capability are configured to retrieve trained ML models and corresponding trustworthiness parameters. In some embodiments, the network entity is configured to use a NWDAF discovery procedure to discover one or more NWDAFs supporting the AnLF with the trustworthiness capability. In some embodiments, the network entity is configured to discover the NWDAF supporting the AnLF with the trustworthiness capability via the NRF. In some embodiments, per each analytics ID, information is included for trustworthiness related parameters per analytics filter information. In some embodiments, information included for trustworthiness related parameters per analytics filter Information includes: a risk level; a fairness; a robustness; a privacy; a security; a safety; a reliability; and/or a traceability.

In some embodiments, discovering the trustworthiness capability for analytics and/or model includes the NRF including trustworthiness capability provisioning per each ML model. In some embodiments, the NRF includes trustworthiness capability provisioning per each ML model in case no NWDAF deployed in a network; in case no NWDAF supporting the MTLF; or in case the NWDAF supporting the MTLF but not for relevant model IDs and/or models being used by different network functions.

Commercial interests for some embodiments are as follows. 1. Solve issues in the prior art and other issues. 2. Handling of trustworthiness for analytics and for ML models in the 5GC. 3. One of the key required mechanisms is a discovery of the corresponding models supporting trustworthiness parameters, and some embodiments of this invention define how this process can be done, in different cases, related to NWDAF capabilities and direct model provisioning capabilities. Hence, some embodiments of this invention enable trustworthiness service discovery capabilities. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvement to methods and apparatus of charging reporting for AI/ML operation are considered for standardizing.

Further, once AI/ML starts to be adopted in 5G/6G networks, there may be an increasing need in supporting AI/ML trustworthiness. The reasons may include local regulation permitting usage of AI/ML services in the mobile networks compliant to certain level of e.g., fairness; and/or service provider requests from the network equipment providers to support certain level of AI/ML trustworthiness e.g., for robustness and for explainability. Hence some embodiments of this application can be a basis for 3GPP standardization (starting from Release-19) to allow standardized means for such AI/ML trustworthiness and supporting it within the messages structure and by the means of standardized network functions. It is not an “end product”, rather a part of the network implementation to create 5G network product.

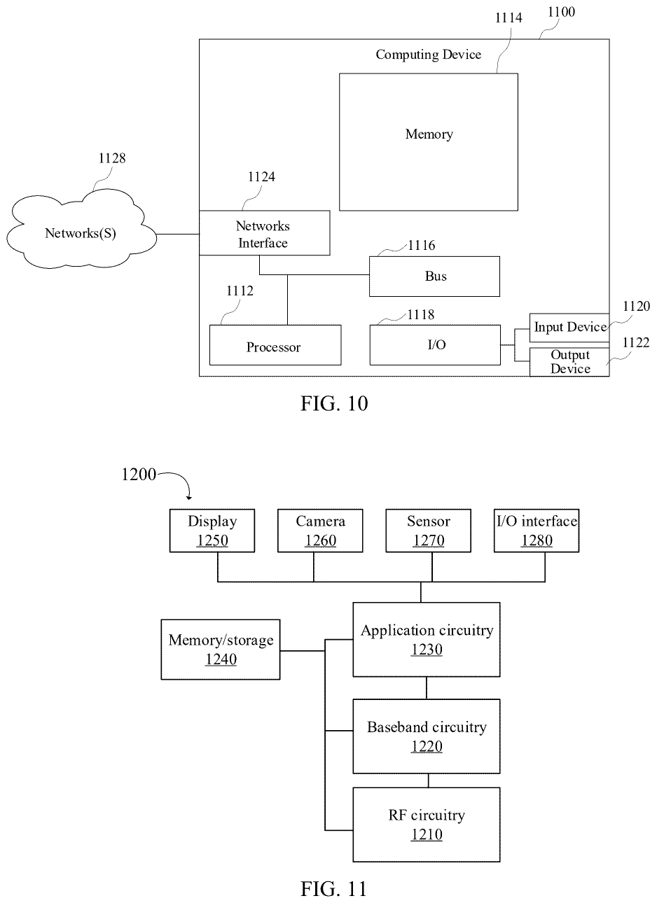

FIG. 10 is an example of a computing device 1100 according to an embodiment of the present disclosure. Any suitable computing device can be used for performing the operations described herein. For example, FIG. 10 illustrates an example of the computing device 1100 that can implement apparatuses and/or methods illustrated in FIG. 1 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 1 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 1 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 1 to FIG. 11 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A communication method for artificial intelligence (AI)/machine learning (ML) operation, wherein the method is implemented in a network entity, comprising:
discovering a trustworthiness capability for analytics and/or models;
wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) comprises trustworthiness capability provisioning per each ML model.

2. The method of claim 1, wherein the NWDAF supporting the MTLF with the trustworthiness capability is locally configured with one or more NWDAF identifiers (IDs) and/or one or more analytics IDs.

3. The method of claim 2, wherein the one or more NWDAF IDs and/or the one or more analytics IDs supported by each NWDAF supporting the MTLF with the trustworthiness capability are configured to retrieve trained ML models and corresponding trustworthiness parameters.

4. The method of claim 1, wherein the network entity is configured to use a NWDAF discovery procedure to discover one or more NWDAFs supporting the MTLF with the trustworthiness capability; or
wherein the network entity is configured to discover the NWDAF supporting the MTLF with the trustworthiness capability via a network repository function (NRF).

5. A network device, comprising:
a memory;
a transceiver; and
a processor coupled to the memory and the transceiver;
wherein the network device is configured to:
discover a trustworthiness capability for analytics and/or models;
wherein a network data analytics function (NWDAF) is enabled to support a model training logical function (MTLF) with the trustworthiness capability for ML models, the NWDAF is enabled to support an analytics logical function (AnLF) with the trustworthiness capability for analytics, or a network repository function (NRF) comprises trustworthiness capability provisioning per each ML model.

6. The network device of claim 5, wherein a network entity is the NWDAF or a NWDAF consumer.

7. The network device of claim 5, wherein the NWDAF supporting the MTLF with the trustworthiness capability is locally configured with one or more NWDAF identifiers (IDs) and/or one or more analytics IDs.

8. The network device of claim 7, wherein the one or more NWDAF IDs and/or the one or more analytics IDs supported by each NWDAF supporting the MTLF with the trustworthiness capability are configured to retrieve trained ML models and corresponding trustworthiness parameters.

9. The network device of claim 6, wherein the network entity is configured to use a NWDAF discovery procedure to discover one or more NWDAFs supporting the MTLF with the trustworthiness capability; or
wherein the network entity is configured to discover the NWDAF supporting the MTLF with the trustworthiness capability via a network repository function (NRF).

10. The network device of claim 6, wherein the NWDAF supporting the MTLF with the trustworthiness capability comprises one or more ML model provisioning services and/or one or more ML trustworthiness services.

11. The network device of claim 10, wherein the NWDAF supporting the MTLF with the trustworthiness capability provides the one or more ML model provisioning services and/or the one or more ML trustworthiness services during a registration in the NRF when trained ML models are available for one or more analytics IDs.

12. The network device of claim 10, wherein the one or more ML model provisioning services and/or the one or more ML trustworthiness services comprise priorities for fall-back mechanism between a trustworthy AI solution, a non-trustworthy AI solution, and a non-AI solution to ensure safety; and/or one or more analytics IDs corresponding to the trained ML models and a ML model filter information for the trained ML model per analytics ID.

13. The network device of claim 12, wherein the ML model filter information comprises at least one of following trustworthiness related parameters: a data type; a version; a sampling frequency; sampling weights; a model weight in case of chaining/merging with another model; labelled/un-labelled data; an explainability level; a risk level; a fairness; a robustness; a privacy; a security; a safety; a reliability; a traceability; a ML decision confidence score; and/or a value quality score of data.

14. The network device of claim 10, wherein a list of the one or more analytics IDs is correlated between the one or more ML model provisioning services and the one or more ML trustworthiness service.

15. The network device of claim 5, wherein the NWDAF supporting the AnLF with the trustworthiness capability is locally configured with one or more NWDAF IDs and/or one or more analytics IDs.

16. The network device of claim 15, wherein the one or more NWDAF IDs and/or the one or more analytics IDs supported by each NWDAF supporting the AnLF with the trustworthiness capability are configured to retrieve trained ML models and corresponding trustworthiness parameters.

17. The network device of claim 5, wherein network entity is configured to use a NWDAF discovery procedure to discover one or more NWDAFs supporting the AnLF with the trustworthiness capability; or
wherein the network entity is configured to discover the NWDAF supporting the AnLF with the trustworthiness capability via the NRF.

18. The network device of claim 17, wherein per each analytics ID, information is included for trustworthiness related parameters per analytics filter information.

19. The network device of claim 18, wherein information included for trustworthiness related parameters per analytics filter Information comprises: a risk level; a fairness; a robustness; a privacy; a security; a safety; a reliability; and/or a traceability.

20. The network device of claim 5, wherein the NRF comprises trustworthiness capability provisioning per each ML model in case no NWDAF deployed in a network; in case no NWDAF supporting the MTLF; or in case the NWDAF supporting the MTLF but not for relevant model IDs and/or models being used by different network functions.
